(19) United States
(12) Patent Application Publication
(10) Pub. No.: US 2022/0191574 A1
(43) Pub. Date: Jun. 16, 2022

(54) METHOD FOR UPLOADING VIDEO AND CLIENT

(71) Applicant: BEIJING DAJIA INTERNET INFORMATION TECHNOLOGY CO., LTD., Beijing (CN)

(72) Inventors: Xing WEN, Beijing (CN); Yunfei ZHENG, Beijing (CN); Bing YU, Beijing (CN); Xiaonan WANG, Beijing (CN); Min CHEN, Beijing (CN); Yue HUANG, Beijing (CN); Yucong CHEN, Beijing (CN); Xiaozheng HUANG, Beijing (CN); Mingfei ZHAO, Beijing (CN); Lei GUO, Beijing (CN); Bo HUANG, Beijing (CN); Jiejun ZHANG, Beijing (CN); Bin CHEN, Beijing (CN)

(21) Appl. No.: 17/685,294

(22) Filed: Mar. 2, 2022

Related U.S. Application Data
(63) Continuation of application No. PCT/CN2020/102752, filed on Jul. 17, 2020.

(30) Foreign Application Priority Data
Sep. 11, 2019 (CN) 201910860878.5

(51) Int. Cl. H04N 21/2743; H04N 21/234; H04N 19/14; H04N 19/159

(52) U.S. Cl. CPC H04N 21/2743; H04N 19/159; H04N 19/14; H04N 21/23418

(57) ABSTRACT

A method for uploading video, executed by a client and including: determining encoding complexity of a target video; determining a target encoding parameter corresponding to difference information based on the difference information between the encoding complexity and a complexity threshold; and encoding the target video based on the target encoding parameter and uploading an encoded target video to a server.

### CROSS-REFERENCE TO RELATED APPLICATION

This application is a continuation application of International Application No. PCT/CN2020/102752, filed on Jul. 17, 2020, which claims the benefit of priority to Chinese Application No. 201910860878.5, filed on Sep. 11, 2019, both of which are incorporated by reference herein.

### TECHNICAL FIELD

The present disclosure relates to the technical field of video processing, and in particular, to a method for uploading video, and a client.

### BACKGROUND

In recent years, as the Internet rapidly develops, websites or applications mainly related to short user-generated content (UGC) videos have rapidly sprung up, and a growing number of users have become creators of network content.

### SUMMARY

The present disclosure provides a method for uploading video, and a client to improve a video encoding effect. The technical solutions of the present disclosure are as follows.

According to one aspect, a method for uploading video is provided. The method is executed by a client and includes:

determining encoding complexity of a target video;

determining a target encoding parameter corresponding to difference information based on the difference information between the encoding complexity and a complexity threshold; and

encoding the target video based on the target encoding parameter and uploading an encoded target video to a server.

According to one aspect, an apparatus for uploading video is provided. The apparatus is executed by a client and includes:

a determining unit, configured to determine encoding complexity of a target video;

a comparison unit, configured to determine a target encoding parameter corresponding to difference information based on the difference information between the encoding complexity and a complexity threshold; and

an upload unit, configured to encode the target video based on the target encoding parameter and upload an encoded target video to a server.

According to one aspect, a client is provided, including:

a processor; and

a memory configured to store an instruction executable by the processor; wherein

the processor is configured to perform the following steps:

determining encoding complexity of a target video;

determining a target encoding parameter corresponding to difference information based on the difference information between the encoding complexity and a complexity threshold; and

encoding the target video based on the target encoding parameter and uploading an encoded target video to a server.

According to one aspect, a storage medium is provided. When an instruction in the storage medium is executed by a processor of a client, the client is enabled to perform the following steps:

determining encoding complexity of a target video;

determining a target encoding parameter corresponding to difference information based on the difference information between the encoding complexity and a complexity threshold; and

encoding the target video based on the target encoding parameter and uploading an encoded target video to a server.

According to one aspect of the embodiments of the present disclosure, a computer program product is provided. When the computer program product is executed by a processor of a client, the client is enabled to perform the following steps:

determining encoding complexity of a target video;

determining a target encoding parameter corresponding to difference information based on the difference information between the encoding complexity and a complexity threshold; and

encoding the target video based on the target encoding parameter and uploading an encoded target video to a server.

### BRIEF DESCRIPTION OF THE DRAWINGS

The accompanying drawings, which are incorporated in and constitute a part of the specification, illustrate the embodiments of the present disclosure, together with the specification, serve to explain the principles of the present disclosure, and do not constitute an undue limitation to the present disclosure.

FIG. 1 is a flowchart of a method for uploading video according to an embodiment of the present disclosure;

FIG. 2 is another flowchart of a method for uploading video according to an embodiment of the present disclosure;

FIG. 3 is a flowchart of determining encoding complexity in the embodiment shown in FIG. 2.

FIG. 4 is a block diagram of an apparatus for uploading video according to an embodiment of the present disclosure;

FIG. 5 is a block diagram of a client according to an embodiment of the present disclosure;

FIG. 6 is a block diagram of an apparatus for uploading video according to an embodiment of the present disclosure; and

FIG. 7 is a block diagram of another apparatus for uploading video according to an embodiment of the present disclosure.

### DETAILED DESCRIPTION

To make those of ordinary skill in the art better understand the technical solutions of the present disclosure, the following clearly and completely describes the technical solutions in the embodiments of the present disclosure with reference to the accompanying drawings.

In related technologies, a process of sharing a video on a UGC platform by a user includes uploading, transcoding, and delivering the video. However, due to the large video files, a client encodes the video before uploading the video. In the related technologies, an encoding parameter for encoding the video by the client is configured based on historical experience. For a complex video that involves vigorous motion, complex textures, and frequent scene changes, if the configured encoding parameter have a larger compression rate for the video, a video bit rate is excessively low, and video quality is reduced. For a simple video that involves gentle motion, smooth texture, and a single static scene, if the configured encoding parameter have a smaller compression rate for the video, a video bit rate is excessively high, encoding redundancy exists, a success rate of uploading the video is reduced, and a video encoding effect is bad.

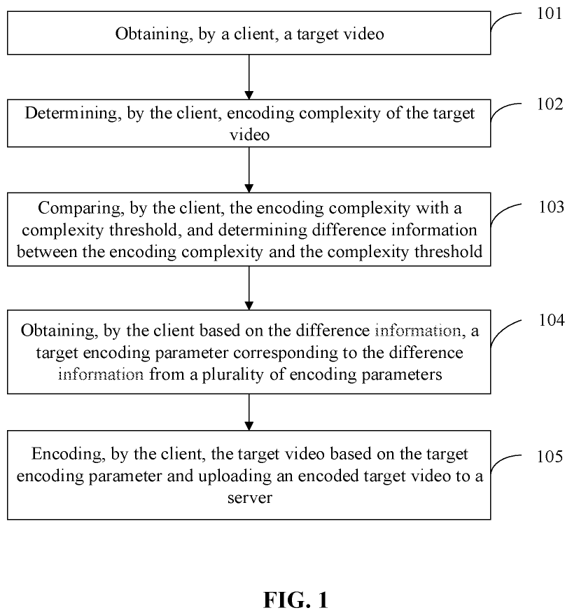

FIG. 1 is a flowchart of a method for uploading video according to an embodiment of the present disclosure. As shown in FIG. 1, the method for uploading video is executed by a client and includes the following steps.

In 101, a target video is obtained by the client.

In some embodiments, the client imports the target video front a local album, that is, the target video is a local video. Alternatively, the target video may be shot by a user through the client after a video upload application running on the client obtains a shooting permission. Alternatively, the client may obtain the target video from the Internet. This is not limited in this embodiment of the present disclosure. In some embodiments, a format of the target video may be AVI (Audio Video Interleaved), MP4 (Moving Picture Experts Group 4), WMA (Windows Media Audio), or RMVB (Real Media Variable Bit rate).

In 102, encoding complexity of the target video is determined by the client.

The encoding complexity of the target video indicates the difficulty of encoding the target video. The higher the encoding complexity, the more computing resources required to be consumed during encoding the target video, and the longer the encoding time. The lower the encoding complexity, the less computing resources required to be consumed during encoding the target video, and the shorter the encoding time.

In some embodiments, the client determines the encoding complexity of the target video based on a video predictive encoding algorithm. The video predictive encoding algorithm determines the encoding complexity of the target video by simulating the process of encoding the target video.

In 103, the encoding complexity is compared by the client with a complexity threshold, and difference information between the encoding complexity and the complexity threshold is determined.

The complexity threshold is set by a person skilled in the art according to the actual situation, or determined by the client according to the operational capability. For example, the higher the operational capability of the client, the higher the complexity threshold is determined; and the lower the operational capability of the client, the lower the complexity threshold is determined.

In 104, a target encoding parameter corresponding to the difference information is obtained by the client from a plurality of encoding parameters based on the difference information.

In some embodiments, the encoding parameters may be preset by the user. In some other embodiments, the encoding parameters may be generated by the client based on historical encoding processes. This is not limited in this embodiment of the present disclosure.

In 105, the target video is encoded by the client based on the target encoding parameter, and an encoded target video is uploaded to a server.

It can be learned that in the present disclosure, before encoding the target video, the client determines the encoding complexity of the target video, and determines the target encoding parameter for encoding the target video based on the difference between the encoding complexity and the complexity threshold. The target encoding parameter is an encoding parameter that matches the encoding complexity of the target video. The client encodes the target video based on the determined target encoding parameter, which can make the determined encoding parameter match more target video, and realize the technical solution of adjusting the encoding parameter for the target video based on the encoding complexity of the target video, and the video encoding effect is better.

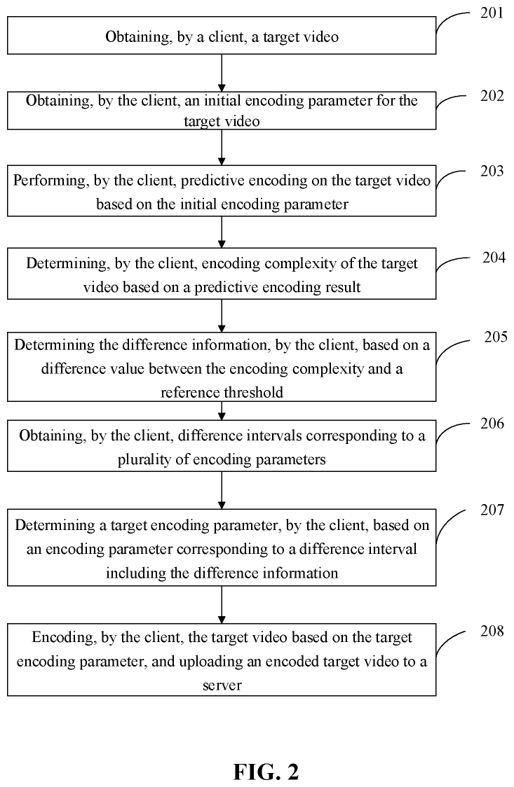

FIG. 2 is another flowchart of a method for uploading video according to an embodiment of the present disclosure. As shown in FIG. 2, the method for uploading video is executed by a client and includes the following steps.

In 201, a target video is obtained by the client.

Please refer to 101 for the step of obtaining the target video by the client, which will not be repeated herein.

In some embodiments, when shooting the target video, a shooting device encodes the target video. Encoding includes a hardware encoding and a software encoding. The hardware encoding has higher real-time performance while the software encoding has better encoding effect. In a case that the shooting device uses the hardware, in addition to obtaining the target video, the client may also obtain hardware encoded data of the target video from video information of the target video. Hardware encoded data is the data obtained after the recording device encodes the target video, and the video information is the information carrying the hardware encoded data.

In 202, an initial encoding parameter for the target video is obtained by the client.

In some embodiments, the initial encoding parameter is the encoding parameter preset based on historical encoding parameters and the historical encoding parameters are encoding parameters corresponding to videos previously undated by the client.

In some embodiments, the client may determine a historical encoding parameter of a historically uploaded video whose hardware encoded data is the same as the hardware encoded data of the target video from a plurality of historically uploaded videos, and takes the historical encoding parameter as the initial encoding parameter.

Alternatively, the client may take an average of the historical encoding parameters as the initial encoding parameter for the target video.

Alternatively, the client may determine an encoding parameter of a last uploaded video as the initial encoding parameter for the target video.

The foregoing examples are merely for ease of understanding. In some other possible implementations, the client may obtain the initial encoding parameter for the target video in other ways. This is not limited in this embodiment of the present disclosure.

In 203, the client performs predictive encoding on the target video based on the initial encoding parameter.

The predictive encoding is performed to check whether the initial encoding parameter is an appropriate encoding parameter for the target video.

In some embodiments, the client may perform predictive encoding on a first target number of image frames of the target video to obtain a predictive encoding result, where the predictive encoding result is used to indicate the encoding complexity during encoding the target video based on the initial encoding parameter.

In this implementation, the client does not need to perform predictive encoding on all image frames of the target video, but only needs to perform encoding on the target number of image frames. This improves a speed of obtaining the predictive encoding result and reduces a calculation amount of the client.

In some embodiments, if the initial encoding parameter is 200 KB/s, the client captures first 20 image frames from the target video, and encodes the 20 image frames based on the initial encoding parameter of 200 KB/s to obtain a predictive encoding result of 20 encoded image frames. The client uses the predictive encoding result of the first 20 image frames to represent the predictive encoding result of the target video.

In 204, encoding complexity of the target video is determined by the client based on the predictive encoding result.

In some embodiments, the encoding complexity may be represented by duration of an encoding process or a peak signal-to-noise ratio before and after encoding.

For example, the encoding complexity is represented by duration of the predictive encoding process. The client determines time consumed by the predictive encoding performed on the target video by using the initial encoding parameter, and determines the encoding complexity of the target video based on the time consumed by the predictive encoding and duration of the target video. For example, the client uses the initial encoding parameter of 200 KB/s to perform the predictive encoding on the target video, and the duration of the target video is 30 s. If the predictive encoding performed by the client on the target video consumes 20 s, the client divides the duration 30 s of the target video by the time 20 s consumed by the predictive encoding to obtain the encoding complexity 1.5 of the target video. In this case, the higher the value corresponding to encoding complexity, the lower the difficulty of encoding the target video. In some embodiments, if the predictive encoding performed by the client on the target video consumes 20 s, the client divides the time 20 s consumed by the predictive encoding by the duration 30 s of the target video to obtain the encoding complexity 0.66 of the target video. In this case, the higher the value corresponding to encoding complexity, the higher the difficulty of encoding the target video.

Alternatively, the client may perform predictive encoding on the first target number of image frames of the target video, and take time consumed by the predictive encoding as the encoding complexity of the target video. For example, the client captures the first 20 image frames from the target video, performs predictive encoding on the 20 image frames, and takes the time consumed by the predictive encoding performed on the 20 image frames, 3.5 s, as the encoding complexity of the target video.

For example, the encoding complexity is represented by the peak signal-to-noise ratio. The client obtains a first number of reference image frames, wherein the reference image frames are image frames in an initial encoded video which is obtained by performing the predictive encoding on the target video by using the initial encoding parameter. The client obtains initial image frames corresponding to the reference image frames from the target video, and determines a mean squared error between pixel values of each reference image frame and pixel values of a corresponding initial image frame, and obtains a peak signal-to-noise ratio between the reference image frame and the initial image frame based on the mean squared error. The client adds the peak signal-to-noise ratios between the first number of reference image frames and the initial image frames, divides a sum by the first number, and obtains a reciprocal of a quotient to obtain the encoding complexity of the target video. A higher signal-to-noise ratio indicates that the reference image frame is closer to the initial image frame. That is, encoding complexity of the initial image is lower. A lower signal-to-noise ratio indicates that the reference image frame is farther away from the initial image frame. That is, the encoding complexity of the initial image is higher. The client uses the reciprocal of the quotient obtained by dividing the sum of the peak signal-to-noise ratios between the first number of reference image frames and the initial image frames by the first number to obtain the encoding complexity of the target video. For example, the client obtains three reference image frames from the initial encoded video, and determines three initial image frames in the target video that correspond to the three reference image frames. The client determines a mean squared error between pixel values of each of the three reference image frames and pixel values of a corresponding initial image frame, and obtains signal-to-noise ratios of 20 dB, 30 dB, and 40 dB between the three reference image frames and the three initial image frames based on the mean squared error. The client divides a sum of the signal-to-noise ratios of 20 dB, 30 dB, and 40 dB by the first number 3 and obtains a reciprocal of a quotient to obtain the encoding complexity 0.03 for the target video.

In addition, in 203 and 204, the client may first decode the target video to obtain original video data of the target video and then perform intra-frame predictive encoding and inter-frame predictive encoding on the original video data of the target video based on the initial encoding parameter, and calculate the encoding complexity of the target video based on predictive encoding results. The predictive encoding results include inter-frame predictive encoding results and intra-frame predictive encoding results. That is, the encoding complexity of the target video is encoding complexity of original video data of the target video. In some embodiments, during the process of obtaining the original video data of the target video, the client can decode the hardware encoding data of the target video to obtain the original video data of the target video.

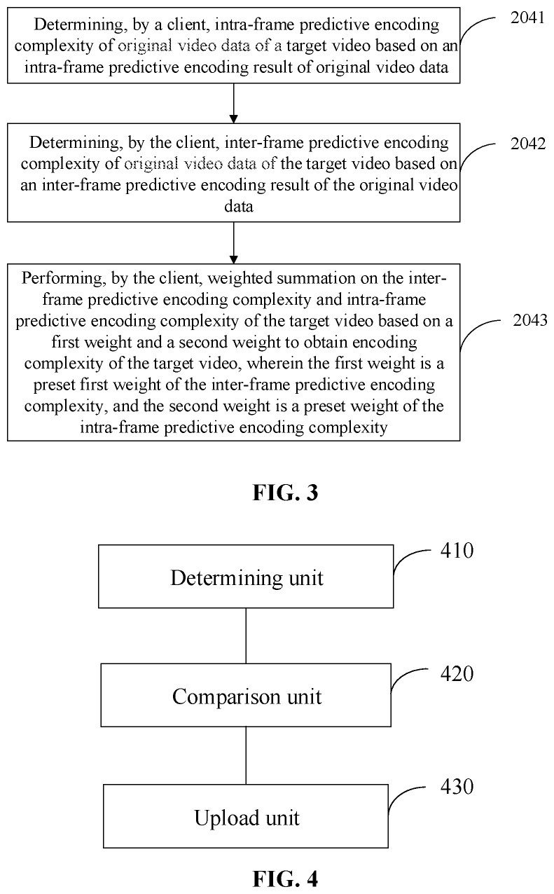

In some embodiments, referring to FIG. 3, the encoding complexity of the target video may be obtained by performing the following steps.

In 2041, intra-frame predictive encoding complexity of the original video data of the target video is determined by the client based on an intra-frame predictive encoding result of the original video data.

In some embodiments, the client obtains a second number of initial image frames from the target video, performs the intra-frame predictive encoding on the second number of initial image frames, and counts total duration of the intra-frame predictive encoding performed on the second number of initial image frames. In some embodiments, the second number of initial image frames are the image frames of the same duration spaced in the target video. The client divides the total duration of the intra-frame predictive encoding by the second number to obtain the intra-frame predictive encoding complexity of the target video.

In 2042, inter-frame predictive encoding complexity of the original video data of the target video is determined by the client based on an inter-frame predictive encoding result of the original video data.

In some embodiments, the client obtains the second number of initial image frames from the target video, performs inter-frame predictive encoding on the second number of initial image frames, and counts total duration of the inter-frame predictive encoding performed on the second number of initial image frames. In some embodiments, the second number of initial image frames are the image frames of the same duration spaced in the target video. The client divides the total duration of the inter-frame predictive encoding by the second number to obtain the inter-frame predictive encoding complexity of the target video.

In 2043, weighted summation is performed by the client on the inter-frame predictive encoding complexity and intra-frame predictive encoding complexity of the target video based on a first weight and a second weight to obtain the encoding complexity of the target video. The first weight is a preset weight of the inter-frame predictive encoding complexity and the second weight is a preset second weight of the intra-frame predictive encoding complexity.

In some embodiments, the first weight and the second weight are set based on a play scenario of the target video. For example, if the target video is delivered to a terminal device with a small screen such as a mobile phone or a tablet computer, a user is insensitive to image details when watching the video. Therefore, the weight of the inter-frame predictive encoding complexity can be increased, and the weight of the intra-frame predictive encoding complexity can be reduced. On the contrary, if the target video needs to be displayed on a larger light-emitting diode (LED) screen, a user is sensitive to image details. Therefore, the weight of the inter-frame predictive encoding complexity can be reduced, and the weight of the intra-frame predictive encoding complexity can be increased.

Alternatively, the first weight and the second weight may be set based on empirical values.

In 205, a difference value between the encoding complexity and a complexity threshold is determined as the difference information by the client.

The complexity threshold may be preset based on statistical data of video quality, an upload success rate and an encoded target video bit rate.

In some embodiments, if the inter-frame predictive encoding complexity of the target video is 2, the intra-frame predictive encoding complexity of the target video is 5, the preset first weight is 0.6, the preset second weight is 0.4, and the complexity threshold is 2.5, the encoding complexity of the target video is 2×0.6+5×0.4=3.2, and the difference between the encoding complexity and the complexity threshold is 0.7.

In 206, difference intervals corresponding to a plurality of encoding parameters are obtained by the client.

Each encoding parameter contains a plurality of parameters used to encode the target video, such as a frame structure, a profile, a coding unit (CU), a transform unit (TU), and a prediction unit (PU).

In 207, an encoding parameter corresponding to a difference interval including the difference information is determined by the client as a target encoding parameter.

In this embodiment, each encoding parameter corresponds to a difference interval. As shown in table 1, encoding parameters 1, 2, . . . , and M correspond to difference intervals [0,0.5), [0.5,1), . . . , and [a,b), respectively. When the difference information between the encoding complexity obtained by the client and the complexity threshold falls within a difference interval in table 1, an encoding parameter corresponding to the difference interval is the target encoding parameter.

In some embodiments, the difference calculated in 205 is 0.7. Referring to table 1, 0.7 ∈ [0.5,1). Therefore, the encoding parameter 2 is determined as the target encoding parameter.

TABLE 1

| Encoding parameter identifier | Difference interval |
|---|---|
| 1 | [0, 0.5) |
| 2 | [0.5, 1) |
| . . . | . . . |
| M | [a, b) |

In 208, the target video is encoded by the client based on the target encoding parameter, and the encoded target video is uploaded to a server.

In addition, after the client uploads the target video to the server, the server can detect whether a user's viewing request is received, and the viewing request contains a type of the user, such as normal user or advanced user. The server transcodes the target video based on the type of the user and pushes a transcoded video to a content delivery network (CDN) server such that a client of the user can obtain the video from the CDN server. For example, if the user that sends the viewing request is a normal user, the server transcodes the target video to an X.264 format. If the user that sends the viewing request is an advanced user, the server transcodes the target video to an X.265 format. In comparison with videos in the X.264 format, videos in the X.265 format have higher image quality, and a file size can be reduced by about 50%, thereby improving experience for advanced users.

In the technical solutions provided by the present disclosure, before encoding the target video, the client determines the encoding complexity of the target video, and determines the target encoding parameter for encoding the target video based on the difference between the encoding complexity and the complexity threshold. The target encoding parameter is an encoding parameter that matches the encoding complexity of the target video. The client encodes the target video based on the determined target encoding parameter, which can make the determined encoding parameter match more target video, and realize the technical solution of adjusting the encoding parameter for the target video based on the encoding complexity of the target video, and the video encoding effect is better.

FIG. 4 is a block diagram of an apparatus for uploading video according to an embodiment of the present disclosure. Referring to FIG. 4, the apparatus includes a determining unit 410, a comparison unit 420, and an upload unit 430.

The determining unit 410 is configured to determine encoding complexity of a target video.

The comparison unit 420 is configured to determine a target encoding parameter corresponding to difference information based on the difference information between the encoding complexity and a complexity threshold.

The upload unit 430 is configured to encode the target video based on the target encoding parameter and upload an encoded target video to a server.

The technical solutions provided by this embodiment of the present disclosure have at least the following beneficial effects: before encoding the target video, an apparatus determines the encoding complexity of the target video, and determines the target encoding parameter for encoding the target video based on the difference between the encoding complexity and the complexity threshold. The target encoding parameter is an encoding parameter that matches the encoding complexity of the target video. The apparatus encodes the target video based on the determined target encoding parameter, which can make the determined encoding parameter match more the target video, and realize the technical solution of adjusting the encoding parameter for the target video based on the encoding complexity of the target video, and the video encoding effect is better.

In some embodiments, the determining unit 410 is configured to decode the target video to obtain original video data of the target video, and to determine the encoding complexity of the target video based on encoding complexity during encoding the original video data.

In some embodiments, the determining unit 410 is configured to decode the hardware data of the target video to obtain the obtain original video data of the target video.

In some embodiments, the determining unit 410 is configured to obtain an initial encoding parameter of the target video; perform inter-frame predictive encoding and intra-frame predictive encoding on the original video data of target video based on the initial encoding parameter; and determine the encoding complexity during encoding the original video data based on an inter-frame predictive encoding result and intra-frame predictive encoding result of the original video data.

In some embodiments, the determining unit 410 is configured to determine inter-frame predictive encoding complexity of the original video data of the target video based on the inter-frame predictive encoding result; determine intra-frame predictive encoding complexity of the original video data of the target video based on the intra-frame predictive encoding result; and perform weighted summation on the inter-frame predictive encoding complexity and intra-frame predictive encoding complexity of the target video based on a first weight and a second weight and to obtain the encoding complexity of the target video. The first weight is a preset weight of the inter-frame predictive encoding complexity and the second weight is a preset weight of the intra-frame predictive encoding complexity.

In some embodiments, the comparison unit 420 is configured to obtain the target encoding parameter corresponding to the difference information from a plurality of encoding parameters based on the difference information between the encoding complexity and the complexity threshold.

In some embodiments, the comparison unit 420 is configured to obtain a difference interval corresponding to each encoding parameter; and determine an encoding parameter corresponding to a difference interval including the difference information as the target encoding parameter.

In some embodiments, the apparatus for uploading video may further include:

a difference determining unit, configured to determine the difference information between the encoding complexity and the complexity threshold.

Specific manners of operations performed by the modules in the apparatus in the foregoing embodiment have been described in detail in the embodiments of the related method, and details are not described herein again.

The present disclosure further provides an electronic device, which may be implemented as a client which includes a processor, and a memory configured to store an instruction executable by the processor, wherein the processor is configured to perform the following steps.

determining encoding complexity of a target video;

determining a target encoding parameter corresponding to difference information based on the difference information between the encoding complexity and a complexity threshold; and

encoding the target video based on the target encoding parameter and uploading an encoded target video to a server.

In some embodiments, the processor is configured to perform the following steps:

decoding the target video to obtain original video data of the target video; and

determining encoding complexity of the target video based on encoding complexity during encoding the original video data of the target video.

In some embodiments, the processor is configured to perform the following step:

decoding hardware encoded data of the target video to obtain the original video data of the target video.

In some embodiments, the processor is configured to perform the following steps:

obtaining an initial encoding parameter for the target video; performing inter-frame predictive encoding and intra-frame predictive encoding on the original video data of the target video based on the initial encoding parameter; and determining the encoding complexity during encoding the original video data of the target video based on an inter-frame predictive encoding result and intra-frame predictive encoding result of the original video data of the target video.

In some embodiments, the processor is configured to perform the following steps:

determining inter-frame predictive encoding complexity of the original video data of the target video based on the inter-frame predictive encoding result;

determining intra-frame predictive encoding complexity of the original video data of the target video based on the intra-frame predictive encoding result; and

performing weighted summation on the inter-frame predictive encoding complexity and intra-frame predictive encoding complexity based on a first weight and a second weight to obtain the encoding complexity of the target video, wherein the first weight is a preset weight of the inter-frame predictive encoding complexity and the second weight is a preset weight of the intra-frame predictive encoding complexity.

In some embodiments, the processor is configured to perform the following step:

obtaining the target encoding parameter corresponding to the difference information from a plurality of encoding parameters based on the difference information between the encoding complexity and the complexity threshold.

In some embodiments, the processor is configured to perform the following steps:

obtaining difference intervals corresponding to the plurality of encoding parameters; and determining the target encoding parameter based on the difference intervals corresponding to the plurality of encoding parameters, wherein the target encoding parameter is an encoding parameter corresponding to a difference interval comprising the difference information.

In some embodiments, the processor is configured to perform the following step:

determining a difference value between the encoding complexity and the complexity threshold as the difference information.

The following describes the structure of the client, as shown in FIG. 5, the electronic device includes a processor 501, a communications interface 502, a memory 503, and a communications bus 504. The processor 501, the communications interface 502, and the memory 503 communicate with each other through the communications bus 504.

The communications bus in the electronic device may be a peripheral component interconnect (PCI) bus, an extended industry standard architecture (EISA) bus, or the like. The communications bus may be classified as an address bus, a data bus, a control bus, or the like. For ease of representation, only one thick line is used to represent the communications bus in the figure, but this does not mean that there is only one bus or only one type of bus.

The communications interface is used for communication between the foregoing client and another device.

The memory may include a random access memory (RAM), or a non-volatile memory, for example, at least one magnetic disk memory. In some embodiments, the memory may alternatively be at least one storage apparatus located far away from the foregoing processor.

The processor may be a general-purpose processor, including a central processing unit (CPU), a network processor (NP), or the like; or may be a digital signal processor (DSP), an application-specific integrated circuit (ASIC), a field-programmable gate array (FPGA), another programmable logic device (PLD), a discrete gate or transistor logic device, or a discrete hardware component.

In another embodiment of the present disclosure, a computer-readable storage medium is further provided. The computer-readable storage medium stores a computer program. The computer program is executed by a processor to perform the following steps.

determining encoding complexity of a target video;

determining a target encoding parameter corresponding to difference information based on the difference information between the encoding complexity and a complexity threshold; and

encoding the target video based on the target encoding parameter and uploading an encoded target video to a server.

In some embodiments, the client further performs the following steps:

decoding the target video to obtain original video data of the target video; and

determining encoding complexity of the target video based on encoding complexity during encoding the original video data of the target video.

In some embodiments, the client further performs the following step: decoding hardware encoded data of the target video to obtain the original video data of the target video.

In some embodiments, the client further performs the following steps:

obtaining an initial encoding parameter for the target video; performing inter-frame predictive encoding and intra-frame predictive encoding on the original video data of the target video based on the initial encoding parameter; and determining the encoding complexity during encoding the original video data of the target video based on an inter-frame predictive encoding result and an intra-frame predictive encoding result of the original video data of the target video.

In some embodiments, the determining the encoding complexity during encoding the original video data of the target video based on the inter-frame predictive encoding result and the intra-frame predictive encoding result of the original video data of the target video includes:

determining inter-frame predictive encoding complexity of the original video data of the target video based on the inter-frame predictive encoding result;

determining intra-frame predictive encoding complexity of the original video data of the target video based on the intra-frame predictive encoding result; and

performing weighted summation on the inter-frame predictive encoding complexity and intra-frame predictive encoding complexity based on a first weight and a second weight to obtain the encoding complexity during encoding the original video data of the target video, wherein the first weight is a preset weight of the inter-frame predictive encoding complexity and the second weight is a preset weight of the intra-frame predictive encoding complexity.

In some embodiments, the determining the target encoding parameter corresponding to the difference information based on the difference information between the encoding complexity and the complexity threshold includes:

obtaining the target encoding parameter corresponding to the difference information from a plurality of encoding parameters based on the difference information between the encoding complexity and the complexity threshold.

In some embodiments, the obtaining the target encoding parameter corresponding to the difference information from the plurality of encoding parameters based on the difference information between the encoding complexity and the complexity threshold includes:

obtaining difference intervals corresponding to the plurality of encoding parameters;

determining the target encoding parameter based on the difference intervals corresponding to the plurality of encoding parameters, wherein the target encoding parameter is an encoding parameter corresponding to a difference interval comprising the difference information.

In some embodiments, the method further includes:

determining a difference value between the encoding complexity and the complexity threshold as the difference information.

In another embodiment of the present disclosure, a computer program product containing an instruction is further provided. When the instruction is run on a computer, the computer is enabled to perform any one of the steps of the method for uploading video in the foregoing method embodiments.

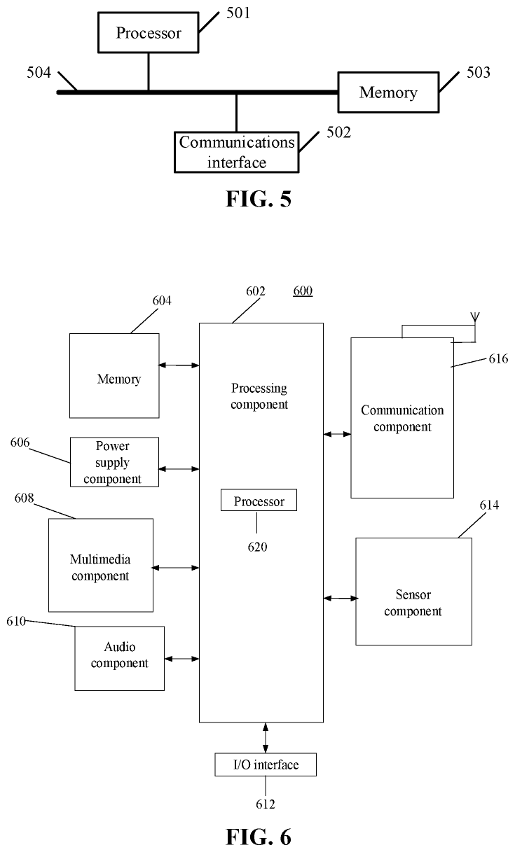

FIG. 6 is a block diagram of an apparatus for uploading video 600 according to an embodiment of the present disclosure. For example, the apparatus 600 may be a mobile phone, a computer, a digital broadcast terminal, a message transmit-receive device, a gaming console, a tablet device, a medical device, a fitness device, a personal digital assistant, or the like.

Referring to FIG. 6, the apparatus 600 may include one or more of the following components: a processing component 602, a memory 604, a power supply component 606, a multimedia component 608, an audio component 610, an input/output (I/O) interface 612, a sensor component 614, and a communication component 616.

The processing component 602 typically controls the overall operation of the apparatus 600, for example, operations associated with display, phone calls, data communications, camera operations, and recording operations. The processing component 602 may include one or more processors 620 to execute instructions to complete all or some of the steps of the foregoing method.

The memory 604 is configured to store various types of data to support operations on the apparatus 600. Examples of such data include instructions for any application or method operating on the apparatus 600, contact data, phone book data, messages, images, videos, and the like. The memory 604 may be implemented by any type of volatile or non-volatile storage device or a combination thereof, such as a static RAM (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power supply component 606 supplies power to various components of the apparatus 600. The power supply component 606 may include a power management system, one or more power supplies, and other components associated with power generation, management, and distribution for the apparatus 600.

The multimedia component 608 includes a screen providing an output interface between the apparatus 600 and a user. In some embodiments, the screen may include a liquid crystal display (LCD) and a touch panel (TP).

The audio component 610 is configured to output and/or input audio signals. For example, the audio component 610 includes a microphone (MIC) configured to receive external audio signals when the apparatus 600 is in an operating mode, such as a call mode, a recording mode, and a voice recognition mode. The received audio signals may be further stored in the memory 604 or sent via the communication component 616. In some embodiments, the audio component 610 may further include a speaker for outputting audio signals.

The I/O interface 612 provides an interface between the processing component 602 and a peripheral interface module, wherein the peripheral interface module may be a keyboard, a click wheel, a button, or the like. The buttons may include, but are not limited to: a home button, a volume button, a start button, and a lock button.

The sensor component 614 includes one or more sensors for providing status assessment of various aspects of the apparatus 600. For example, the sensor component 614 may detect an on/off state of the apparatus 600 and relative positions of the components. For example, the components are a display and a keypad of the apparatus 600. The sensor component 614 may further detect position changes of the apparatus 600 or a component of the apparatus 600, presence or absence of contact between the user and the apparatus 600, positions or acceleration/deceleration of the apparatus 600, and temperature changes of the apparatus 600. The sensor component 614 may include a proximity sensor configured to detect the presence of nearby objects without any physical contact. The sensor component 614 may further include an optical sensor, such as a complementary metal-oxide-semiconductor (CMOS) or charge-coupled device (CCD) image sensor, for use in imaging applications.

The communication component 616 is configured to facilitate communication between the apparatus 600 and other devices by wired or wireless means. The apparatus 600 may access a wireless network based on a communication standard, such as wireless fidelity (Wi-Fi), a carrier network (for example, 2G, 3G, 4G, or 5G), or a combination thereof.

In an exemplary embodiment, the apparatus 600 may be implemented by one or more ASICs, DSPs, digital signal processing devices (DSPDs), PLDs, FPGAs, controllers, microcontrollers, microprocessors, or other electronic elements for performing any one of the steps of the foregoing method for uploading video.

In an exemplary embodiment, a storage medium including an instruction may be further provided, such as the memory 604 including an instruction. The instruction may be executed by the processor 620 of the apparatus 600 to perform the foregoing method. In some embodiments, the storage medium may be a non-transitory computer-readable storage medium, for example, the non-transitory computer-readable storage medium may be a read-only memory (ROM), a random access memory (RAM), a compact disc read-only memory (CD-ROM), a magnetic tape, a floppy disk, an optical data storage device, or the like.

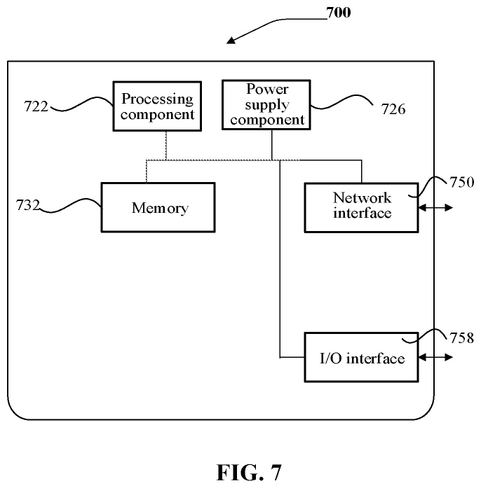

FIG. 7 is a block diagram of an apparatus for uploading video 700 according to an embodiment of the present disclosure. For example, the apparatus 700 may be provided as a client. Referring to FIG. 7, the apparatus 700 includes a processing component 722, which further includes one or more processors; and a memory resource represented by a memory 732, for storing instructions executable by the processing component 722, such as an application program. The application program stored in the memory 732 may include one or more modules each corresponding to a set of instructions. In addition, the processing component 722 is configured to execute the instructions to perform any one of the steps of the foregoing method for uploading video.

The apparatus 700 may further include a power supply component 726 configured to perform power management of the apparatus 700, a wired or wireless network interface 750 configured to connect the apparatus 700 to a network, and an I/O interface 758. The apparatus 700 can operate based on an operating system stored in the memory 732, such as Windows Server, Mac OS X, Unix, Linux, and FreeBSD.

It should be noted that, the present disclosure is not limited to the precise structures that have been described above and shown in the accompanying drawings, and can be modified and changed in many ways without departing from the scope of the present disclosure. The scope of the present disclosure is defined by the appended claims.

What is claimed is:

1. A method for uploading video, applied to a client, the method comprising:
acquiring a to-be-uploaded video;
determining encoding complexity of the to-be-uploaded video;
determining a difference between the encoding complexity and a preset threshold by comparing the encoding complexity and the preset threshold;
acquiring a target encoding parameter in an encoding parameter set corresponding to the difference from a plurality of preset encoding parameter sets according to the difference; and
encoding the to-be-uploaded video based on the target encoding parameter and uploading an encoded to-be-uploaded video to a server.

2. The method for uploading video according to claim 1, wherein,
said acquiring the to-be-uploaded video comprises:
acquiring hardware encoded data of the to-be-uploaded video;
before the determining encoding complexity of the to-be-uploaded video, the method further comprises:
decoding the hardware encoded data of the to-be-uploaded video to obtain original video data of the to-be-uploaded video; and
said determining encoding complexity of the to-be-uploaded video comprises:
determining encoding complexity during encoding the original video data of the to-be-uploaded video.

3. The method for uploading video according to claim 1, wherein said determining encoding complexity of the to-be-uploaded video comprises:
obtaining an initial encoding parameter for the to-be-uploaded video, wherein the initial encoding parameter is preset based on historical encoding parameters;
performing inter-frame predictive encoding and intra-frame predictive encoding on the to-be-uploaded video based on the initial encoding parameter; and
calculating the encoding complexity of the to-be-uploaded video based on an inter-frame predictive encoding result and an intra-frame predictive encoding result.

4. The method for uploading video according to claim 3, wherein said calculating the encoding complexity of the to-be-uploaded video based on the inter-frame predictive encoding result and the intra-frame predictive encoding result comprises:
calculating inter-frame predictive encoding complexity of the to-be-uploaded video based on the inter-frame predictive encoding result;
calculating intra-frame predictive encoding complexity of the to-be-uploaded video based on the intra-frame predictive encoding result; and
performing weighted summation on the inter-frame predictive encoding complexity and intra-frame predictive encoding complexity of the to-be-uploaded video based on a preset first weight of the inter-frame predictive encoding complexity and a preset second weight of the intra-frame predictive encoding complexity to obtain an encoding complexity value of the to-be-uploaded video.

5. The method for uploading video according to claim 4, wherein said determining the difference between the encoding complexity and the preset threshold by comparing the encoding complexity and the preset threshold comprises:
calculating a difference value between the encoding complexity value and a preset threshold;
said acquiring the target encoding parameter in the encoding parameter set corresponding to the difference from the plurality of preset encoding parameter sets according to the difference comprises:
obtaining a preset difference value interval corresponding to each encoding parameter set;
determining an encoding parameter set corresponding to a difference value interval comprising the difference value as the target encoding parameter set; and
obtaining and determining encoding parameters in the target encoding parameter set as the target encoding parameter.

6. A client, comprising:
a processor; and
a memory configured to store an instruction executable by the processor; wherein the processor is configured to execute the instruction to perform the following steps:
acquiring a to-be-uploaded video;
determining encoding complexity of the to-be-uploaded video;
determining a difference between the encoding complexity and a preset threshold by comparing the encoding complexity and the preset threshold;
acquiring a target encoding parameter in an encoding parameter set corresponding to the difference from a plurality of preset encoding parameter sets according to the difference; and
encoding the to-be-uploaded video based on the target encoding parameter and uploading an encoded to-be-uploaded video to a server.

7. The client according to claim 6, wherein said acquiring the to-be-uploaded video comprises:
acquiring hardware encoded data of the to-be-uploaded video;
before the determining encoding complexity of the to-be-uploaded video, the method further comprises:
decoding the hardware encoded data of the to-be-uploaded video to obtain original video data of the to-be-uploaded video; and
said determining encoding complexity of the to-be-uploaded video comprises:
determining encoding complexity during encoding the original video data of the to-be-uploaded video.

8. The client according to claim 6, wherein said determining encoding complexity of the to-be-uploaded video comprises:
obtaining an initial encoding parameter for the to-be-uploaded video, wherein the initial encoding parameter is preset based on historical encoding parameters;
performing inter-frame predictive encoding and intra-frame predictive encoding on the to-be-uploaded video based on the initial encoding parameter; and
calculating the encoding complexity of the to-be-uploaded video based on an inter-frame predictive encoding result and an intra-frame predictive encoding result.

9. The client according to claim 8, wherein said calculating the encoding complexity of the to-be-uploaded video based on the inter-frame predictive encoding result and the intra-frame predictive encoding result comprises:
calculating inter-frame predictive encoding complexity of the to-be-uploaded video based on the inter-frame predictive encoding result;
calculating intra-frame predictive encoding complexity of the to-be-uploaded video based on the intra-frame predictive encoding result; and
performing weighted summation on the inter-frame predictive encoding complexity and intra-frame predictive encoding complexity of the to-be-uploaded video based on a preset first weight of the inter-frame predictive encoding complexity and a preset second weight of the intra-frame predictive encoding complexity to obtain an encoding complexity value of the to-be-uploaded video.

10. The client according to claim 9, wherein said determining the difference between the encoding complexity and the preset threshold by comparing the encoding complexity and the preset threshold comprises:
calculating a difference value between the encoding complexity value and a preset threshold;
said acquiring the target encoding parameter in the encoding parameter set corresponding to the difference from the plurality of preset encoding parameter sets according to the difference comprises:
obtaining a preset difference value interval corresponding to each encoding parameter set;
determining an encoding parameter set corresponding to a difference value interval comprising the difference value as the target encoding parameter set; and
obtaining and determining encoding parameters in the target encoding parameter set as the target encoding parameter.

11. A non-transitory computer readable storage medium, wherein a computer program in the storage medium is executed by a processor of a client, the client performs the following steps:
acquiring a to-be-uploaded video;
determining encoding complexity of the to-be-uploaded video;
determining a difference between the encoding complexity and a preset threshold by comparing the encoding complexity and the preset threshold;
acquiring a target encoding parameter in an encoding parameter set corresponding to the difference from a plurality of preset encoding parameter sets according to the difference; and
encoding the to-be-uploaded video based on the target encoding parameter and uploading an encoded to-be-uploaded video to a server.

12. The storage medium according to claim 11, wherein said acquiring the to-be-uploaded video comprises:
acquiring hardware encoded data of the to-be-uploaded video;
before the determining encoding complexity of the to-be-uploaded video, the method further comprises:
decoding the hardware encoded data of the to-be-uploaded video to obtain original video data of the to-be-uploaded video; and
said determining encoding complexity of the to-be-uploaded video comprises:
determining encoding complexity during encoding the original video data of the to-be-uploaded video.

13. The storage medium according to claim 11, wherein said determining encoding complexity of the to-be-uploaded video comprises:
obtaining an initial encoding parameter for the to-be-uploaded video, wherein the initial encoding parameter is preset based on historical encoding parameters;
performing inter-frame predictive encoding and intra-frame predictive encoding on the to-be-uploaded video based on the initial encoding parameter; and
calculating the encoding complexity of the to-be-uploaded video based on an inter-frame predictive encoding result and an intra-frame predictive encoding result.

14. The storage medium according to claim 13, wherein said calculating the encoding complexity of the to-be-uploaded video based on the inter-frame predictive encoding result and the intra-frame predictive encoding result comprises:
calculating inter-frame predictive encoding complexity of the to-be-uploaded video based on the inter-frame predictive encoding result;
calculating intra-frame predictive encoding complexity of the to-be-uploaded video based on the intra-frame predictive encoding result; and
performing weighted summation on the inter-frame predictive encoding complexity and intra-frame predictive encoding complexity of the to-be-uploaded video based on a preset first weight of the inter-frame predictive encoding complexity and a preset second weight of the intra-frame predictive encoding complexity to obtain an encoding complexity value of the to-be-uploaded video.

15. The storage medium according to claim 14, wherein said determining the difference between the encoding complexity and the preset threshold by comparing the encoding complexity and the preset threshold comprises:
calculating a difference value between the encoding complexity value and a preset threshold;
said acquiring the target encoding parameter in the encoding parameter set corresponding to the difference from the plurality of preset encoding parameter sets according to the difference comprises:
obtaining a preset difference value interval corresponding to each encoding parameter set;
determining an encoding parameter set corresponding to a difference value interval comprising the difference value as the target encoding parameter set; and
obtaining and determining encoding parameters in the target encoding parameter set as the target encoding parameter.
